(19) United States
(12) Patent Application Publication
(10) Pub. No.: US 2016/0104439 A1
(43) Pub. Date: Apr. 14, 2016

(54) DISPLAY DRIVING CIRCUIT INTEGRATING LIGHT SENSOR AND DISPLAY DRIVING CHIP THEREOF

(71) Applicant: INTEGRATED SOLUTIONS TECHNOLOGY INC., Taipei City (TW)

(72) Inventor: WEI-TE LEE, TAIPEI CITY (TW)

(21) Appl. No.: 14/571,353

(22) Filed: Dec. 16, 2014

(30) Foreign Application Priority Data
Oct. 8, 2014 (TW) 103217918

(51) Int. Cl. G09G 3/36; G06F 1/32

(52) U.S. Cl. CPC G09G 3/36; G06F 1/3203; G09G 2330/022

(57) ABSTRACT

A display driving circuit comprises a display driving chip and a control unit. The display driving chip coupled to a display unit is for driving the display unit. The control unit is coupled to the display driving chip, for controlling the display unit to display the item information. The display driving chip controls the display driving circuit to operate in a normal mode or a power saving mode according to a light sensor. When the light sensor senses the light is not sufficient, turning off the display and turning off the power of related circuit to enter the power saving mode. In this way, the problem of power consumption at night or non-use of time can be solved, so as to effectively save the power.

### BACKGROUND OF THE INVENTION

1. Field of the Invention

The instant disclosure relates to a display driving circuit and a display driving chip thereof; in particular, to a display driving circuit controlling a display unit to operate according to a light sensor, and a display driving chip thereof.

2. Description of Related Art

Traditional labels for indicating goods or products are usually printed on paper, and different products require different labels to be affixed. In recent years, electronic tags are increasingly being used to replace the traditional paper labels. In the retail channel, the price information, promotional information, inventory and sales volume and other information can be transmitted to the electronic label in order to alleviate the burden of work on the store-person. Used in the warehouse management industry, the parts' names, specifications, inventory number, date and other parts' ordering information can be communicated to the related workers through the electronic tags, in order to facilitate inventory management arrangements and production operations.

Please refer to FIG. 1 showing a block diagram of a conventional display driving circuit. The control unit 11 receives the product information INF through a wired or wireless means, and transmits the product information INF to the display driving chip 12. Then, the display driving chip 12 drives the display unit 14 to display the received product information INF. For applying this to an electronic tag, the electronic tag usually can be implemented by a liquid crystal display (LCD) cooperating with an integrated battery, thus the electronic tag does not need an external power supply and the electronic tag uses its own power supply by itself. However, the battery powered electronic tags are usually turned on until they run out of battery power. For example, the electronic tags in the marketplace still continue to display in the rest time which is during non-business hours in the evening or at night, such that it is a waste of electricity.

### SUMMARY OF THE INVENTION

The object of the instant disclosure is to provide a display driving circuit and a display driving chip thereof, which utilize the light sensor to control the liquid crystal display unit to turn off the display during non-use time.

In order to achieve the aforementioned objects, according to an embodiment of the instant disclosure, a display driving circuit integrating a light sensor is provided. The display driving circuit integrating the light sensor comprises a display driving chip and a control unit. The display driving chip is coupled to a display unit, and the display driving chip drives the display unit. The control unit is coupled to the display driving chip, for controlling the display unit to display product information through the display driving chip. The display driving chip controls the display driving circuit integrating the light sensor to operate in a normal mode or a power saving mode according to a light sensing signal of the light sensor.

In one exemplary embodiment, a battery is coupled to the control unit and the display driving chip for providing electric power to the control unit and the display driving chip.

In one exemplary embodiment, the display unit is a liquid crystal display or an electric paper.

In one exemplary embodiment, the display unit displays the product information in the normal mode, and the display unit does not display the product information in the power saving mode.

In one exemplary embodiment, the light sensor is disposed on a surface of the display driving chip.

In order to achieve the aforementioned objects, according to an embodiment of the instant disclosure, a display driving chip is provided. The display driving chip is used for driving a display unit. The display driving chip comprises a display driving unit and a light sensor. The display driving unit receives product information through a control unit, and drives the display unit to display the product information. The light sensor is coupled to the display driving unit. The display driving chip operates in a normal mode or a power saving mode according to a light sensing signal of the light sensor.

In one exemplary embodiment, the display unit is a liquid crystal display or an electric paper.

In one exemplary embodiment, the display unit displays the product information in the normal mode, and the display unit does not display the product information in the power saving mode.

In summary, the instant disclosure provides a display driving circuit and a display driving chip thereof. The display driving circuit has the function of turning on/off the display by timing, which is integrated with a light sensor with very low power consumption. The display driving circuit can be applied to the electronic tag. The display is turned off when the light is insufficient (or the brightness of the light is lower than a preset value), and the power of the related circuit is turned off for entering into the power saving mode. Accordingly, the problem of power consumption in the evening or at night can be solved, and electricity can be effectively saved.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a block diagram of a conventional display driving circuit;

FIG. 2 shows a block diagram of a display driving circuit integrating a real time clock or light sensor according to an embodiment of the instant disclosure;

FIG. 3 shows a schematic diagram of an electronic tag applying a display driving circuit integrating a real time clock or light sensor according to an embodiment of the instant disclosure;

FIG. 4 shows a block diagram of a display driving circuit integrating a real time clock or light sensor according to another embodiment of the instant disclosure; and

FIG. 5 shows a block diagram of a display driving circuit integrating a real time clock or light sensor according to another embodiment of the instant disclosure.

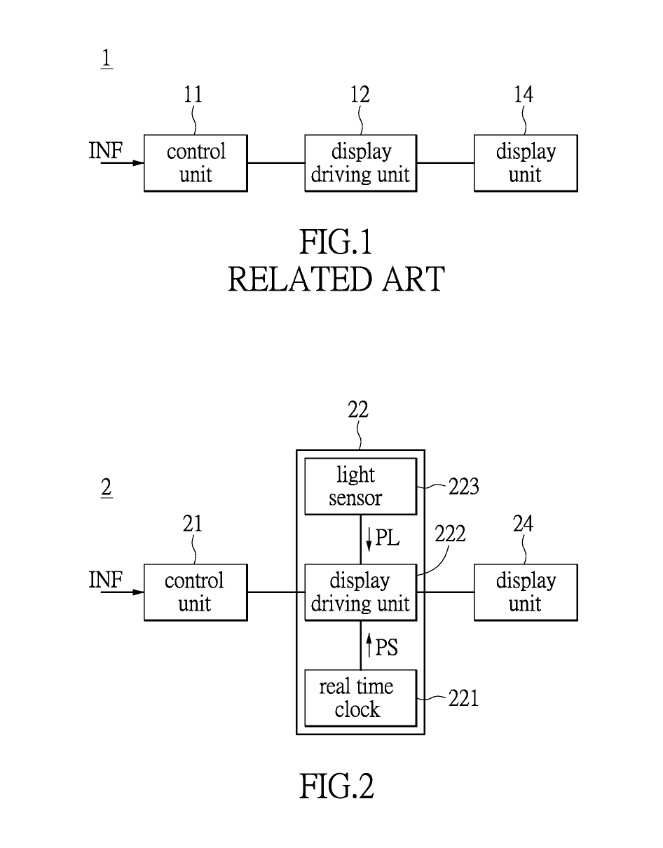

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

An Embodiment of a Display Driving Circuit Integrating a Real Time Clock or a Light Sensor and a Display Driving Chip Thereof

The display driving circuit integrating a real time clock or a light sensor can be applied to an electronic tag, and the electronic tag can be attached on the product or set on the display rack for the product, in order to display the information of the corresponding product, such as the name, size or prize, and so on. However, it is quite a waste of electricity when the electronic tag displays during non-business hours in the evening or at night. The conventional electronic tag is powered by a battery. Accordingly, in order to extend the battery life as long as possible, the instant disclosure provides a solution which is to provide a real time clock built into the electronic tag to flexibly set a certain time period of business hours for display, and turning off the display at the rest time and entering into a power saving mode, or, sensing whether there is light by a light sensor, turning off the display when there is no light (or the brightness of the light is lower than a preset value, which can be the non-business hours in the evening or at night). Accordingly, the effect of power management can be achieved in order to extend the life time of the electronic tag.

Please refer to FIG. 2 showing a block diagram of a display driving circuit integrating a real time clock or a light sensor according to an embodiment of the instant disclosure. The display driving circuit 2 comprises a display driving chip 22 and a control unit 21. The display driving chip 22 comprises a display driving unit 222, a light sensor 223 and a real time clock 221. In practical applications, the display driving chip 22 may only have one of the light sensor 223 or the real time clock 221, and the instant disclosure does not restrict the display driving circuit 2 to having both the light sensor 223 and the real time clock 221 at the same time. The display driving unit 222 comprises a related circuit for driving a display unit 24. The display driving chip 22 is coupled to the display unit 24, and the display driving chip 22 drives the display unit 24. The control unit 21 is coupled to the display driving chip 22, for controlling the display unit 24 to display the product information INF through the display driving chip 22. The control unit 21 can be a micro control unit (MCU), but the instant disclosure is not so restricted. The display driving chip 22 can be implemented by an integrated circuit (IC). The display driving circuit 2 integrating the real time clock 221 can operate in a normal mode or a power saving mode according to the built-in real time clock 221 of the display driving chip 22.

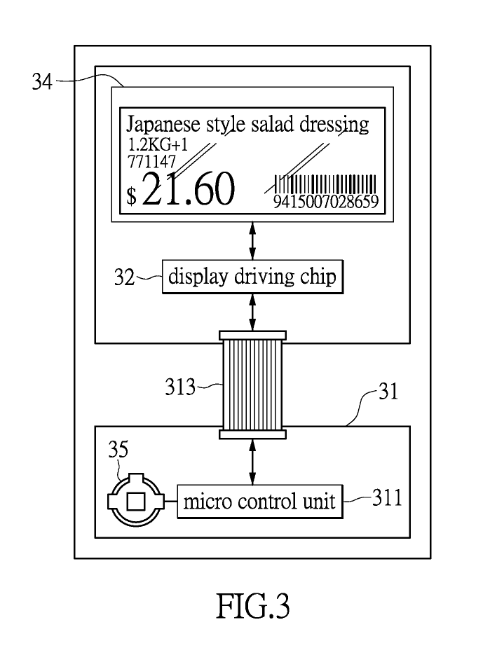

Specifically, the display driving chip 22 is coupled to the display unit 24, for driving the display unit 24. The control unit 21 can receive the product information INF input from exterior, and the control unit 21 has a built-in memory (not shown in the figures) for storing the product information INF, but the instant disclosure is not restricted thereto. When the product information INF corresponding to the display driving circuit 2 integrating the real time clock has to be updated, the control unit 21 can receive and store the new product information INF. The related description of the product information can be referred to in the exemplary embodiment of FIG. 3 thereafter.

The display unit 24 can be a liquid crystal display (LCD), an electronic paper (E-paper) or other display element with related circuit. This instant disclosure does not restrict the type and the operation mechanism of the display unit 24. An artisan of ordinary skill in the art will appreciate the implementation manner of the related circuit for the display driving chip 22 according to the type of the display unit 24, thus there is no need to go into details.

The control unit 24 is coupled to the display driving chip 22, for transmitting the product information INF to the display driving chip 22, such that the display driving chip 22 can control the display unit 24 to display the product information INF. And, the display driving chip 22 can control the display driving circuit 2 integrating the real time clock 221 to operate in the normal mode or the power saving mode according to the built-in real time clock 221. Specifically, in the mentioned normal mode, the display unit 24 displays the product information INF, and in the power saving mode, the display unit 24 does not display the product information INF. For example, during the business hours in the marketplace, the display unit 24 displays the product information INF normally, and in the evening or at night in non-business hours, the display unit 24 is turned off to not display any information and the display unit 24 can be treated as in non-working status at this time, thus the effect of power saving can be achieved. If the power can be turned off for eight hours a day, one-third power consumption can be saved, or the equivalent of increasing by about 50% the life time of the battery.

In one embodiment, the real time clock 221 can generate a power saving signal PS during a predetermined time period, and the power saving signal PS is, for example, for disabling the display driving chip 22. Regarding the real time clock 221 generating the power saving signal PS during the predetermined time period, for example if the predetermined time is set to the non-business hours of the marketplace, the power saving signal PS would be generated when the time reaches the non-business hours, for disabling (the display driving unit 222 of) the display driving chip 22. At the same time, although the real time clock 221 can operate continuously, the display driving unit 222 in the display driving chip 22 would not consume power because of the disabling. Also, at the same time, the display unit 24 does not consume power. When the time of the real time clock 221 is not in the predetermined time period (not in the non-business hours but in the business hours for example), the display driving chip 22 recovers to operate normally for controlling the display unit 24 to display the product information INF.

On the other hand, the display driving chip 22 can also control the display driving circuit 2 to operate in the normal mode or the power saving mode according to a light sensing signal PL of the light sensor 223. When the light sensor 223 senses that the brightness of the light is lower than a preset value, the light sensing signal PL lets the display driving unit 222 control the display unit 24 not to display. The light sensor 24 can be a photoresistor, but the instant disclosure does not restrict the type of the light sensor.

Alternatively, in one embodiment, the real time clock 221 generates the power saving signal PS during a predetermined time period (non-business hours) to control the display unit 24 not to display, and the light sensing signal PL of the light sensor 223 is used to determine whether to control the display unit 24 to display during the time other than the predetermined time. That is, the display unit 24 does not display in non-business hours, and when the light is not sufficient (or lower than a preset value) in the business hours, the display unit 24 also does not display, for further saving the power.

Please refer to FIG. 3 showing a schematic diagram of an electronic tag applying a display driving circuit integrating a real time clock or a light sensor according to an embodiment of the instant disclosure. Regarding the scheme of FIG. 2 as an example, if the control unit 21 is implemented by hardware, a micro control unit 311, a battery 35 and related circuit can be designed on the circuit board 31. The micro control unit 311 can be implemented by an integrated circuit (IC), and the micro control unit 311 can transmit the product information (INF) and related control signal to the display driving chip 32 through a signal transmission interface 313 (for example the signal bus). In FIG. 3, the display driving chip 32 is indicated by a functional block, but the display driving chip 32 can be a chip implemented by an integrated circuit (IC) in practical applications. The display driving chip 32 can be integrated with the display unit 34 on a panel, for example a LCD panel, but the instant disclosure is not restricted thereto. An artisan of ordinary skill in the art will appreciate the implementation manner of the display unit 34, thus there is no need to go into details. Further, the product information INF displayed by the display unit 34 can be the product name, specifications (for example the weight), prize, brand, or purchase-barcode, for being identified by the user, in which the user can be the consumer or the stock manager in the marketplace. In normal mode, the display unit 34 continuously displays the product information shown in FIG. 3. In power saving mode, the display unit 34 does not display the product information shown in FIG. 3, for saving power. It is worth mentioning that the light sensor 223 described in FIG. 2 can be disposed on a surface of the display driving chip 32 of FIG. 3, such that the light sensor 223 can sense light of the environment.

Based on the above, the real time clock can be used to control the display unit not to display during a predetermined time period, for saving power. Furthermore, the real time clock can further be used to turn off the related circuit in the display driving chip or to enter the power saving mode, for further saving power. Alternatively, the light sensing signal of the light sensor can be used to be the basis of controlling the display of the display unit, for saving power. It is worth mentioning that the display driving chip in this embodiment is comprised of the light sensor and the real time clock, but in another embodiment, the light sensor and the real time clock can be set up independently out from the display driving chip, or the light sensor and the real time clock can be installed to the control unit referred to in the descriptions thereafter.

Another Embodiment of a Display Driving Circuit Integrating a Real Time Clock or a Light Sensor and a Display Driving Chip Thereof

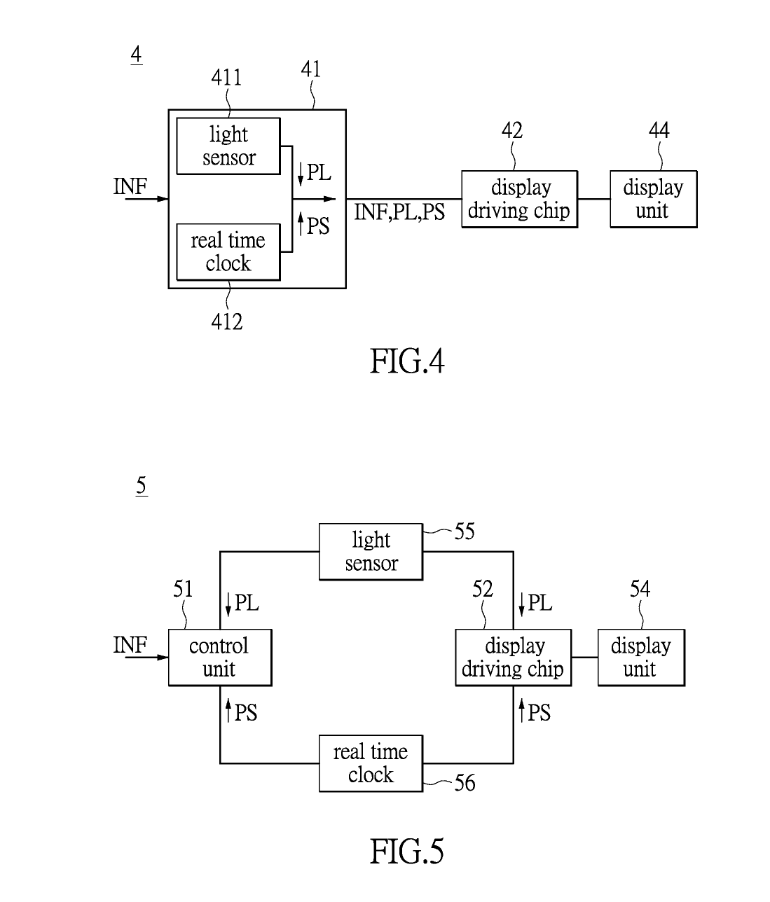

Please refer to FIG. 4, the display driving circuit 4 comprises a display driving chip 42 and a control unit 41. In this embodiment, the control unit 41 comprises a light sensor 411 and a real time clock 412. In practical applications, the control unit 41 can comprise one of the light sensor 411 or the real time clock 412, and the instant disclosure does not restrict the display driving circuit 4 to having both of the light sensor 411 and the real time clock 412 at the same time. The display driving chip 42 comprises a related circuit for driving the display unit 44. The display driving chip 42 is coupled to the display unit 44, for driving the display unit 44. The control unit 41 is coupled to the display driving chip 42, for controlling the display unit 44 to display the product information INF through the display driving chip 42. The control unit 41 can be a micro control unit (MCU) for example, but the instant disclosure is not so restricted. The display driving chip 42 can be implemented by an integrated circuit (IC). The control unit 41 controls the display driving circuit 4 to operate in the normal mode or the power saving mode according to the real time clock 412 or the light sensor 411 of the control unit 41. For example, the operation mode of the display driving circuit 4 is switched according to the power saving signal PS of the real time clock 412 or the light sensing signal PL of the light sensor 411, such that the display unit 44 can be controlled to display the product information INF or not.

Another Embodiment of a Display Driving Circuit Integrating a Real Time Clock or a Light Sensor and a Display Driving Chip Thereof

Please refer to FIG. 5, the display driving circuit 5 comprises a control unit 51, a display driving chip 52, and the light sensor 55 and the real time clock 56 independently from the control unit 51 and the display driving chip 52. In practical applications, only one of the light sensor 411 or the real time clock 412 is needed, and the instant disclosure does not restrict the display driving circuit 5 to having both the light sensor 411 and the real time clock 412 at the same time. The display driving chip 52 comprises a related circuit for driving the display unit 54. The display driving chip 52 is coupled to the display unit 54, for driving the display unit 54. The control unit 51 is coupled to the display driving chip 52, for controlling the display unit 54 to display the product information INF through the display driving chip 52. The control unit 51 can be a micro control unit (MCU) for example, but the instant disclosure is not so restricted. The display driving chip 52 can be implemented by an integrated circuit (IC). The display driving circuit 5 can operate in the normal mode or the power saving mode according to the real time clock 56 or the light sensor 55. For example, the operation mode of the display driving circuit 5 is switched according to the power saving signal PS of the real time clock 56 or the light sensing signal PL of the light sensor 55, such that the display unit 54 can be controlled to display the product information INF or not.

According to the above description, the provided display driving circuit and the display driving chip thereof has the function of turning on/off by timing, integrated with a real time clock (RTC) with very low power consumption. The display driving circuit can be applied to the electronic tag which can be flexibly set to display during certain time periods according to the business hours. The display is turned off during the rest of time, and the power of the related circuit is turned off for entering the power saving mode, or, the display can be turned off when the light of the environment is not sufficient (lower than a preset value). Accordingly, the problem of power consumption in the evening or at night can be solved, and electricity can be effectively saved. If the power can be turned off for eight hours a day, one-third power consumption can be saved, or equivalent of increasing by about 50% the life time of the battery.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A display driving circuit integrating a light sensor, comprising:
a display driving chip, coupled to a display unit, driving the display unit; and
a control unit, coupled to the display driving chip, for controlling the display unit to display product information through the display driving chip, the display driving chip controlling the display driving circuit integrating the light sensor to operate in a normal mode or a power saving mode according to a light sensing signal of the light sensor.

2. The display driving circuit integrating the light sensor according to claim 1, wherein a battery is coupled to the control unit and the display driving chip for providing electric power to the control unit and the display driving chip.

3. The display driving circuit integrating the light sensor according to claim 1, wherein the display unit is a liquid crystal display or an electric paper.

4. The display driving circuit integrating the light sensor according to claim 1, wherein the display unit displays the product information in the normal mode, and the display unit does not display the product information in the power saving mode.

5. The display driving circuit integrating the light sensor according to claim 1, wherein the light sensor is disposed on a surface of the display driving chip.

6. A display driving chip, used for driving a display unit, the display driving chip comprising:
a display driving unit, receiving product information through a control unit, and driving the display unit to display the product information; and
a light sensor, coupled to the display driving unit;
wherein the display driving chip operates in a normal mode or a power saving mode according to a light sensing signal of the light sensor.

7. The display driving chip according to claim 6, wherein the display unit is a liquid crystal display or an electric paper.

8. The display driving chip according to claim 6, wherein the display unit displays the product information in the normal mode, the display unit does not display the product information in the power saving mode.
